(19) United States
(12) Patent Application Publication
(10) Pub. No.: US 2025/0286330 A1
(43) Pub. Date: Sep. 11, 2025

(54) Electrical Connector

(71) Applicants: Dongguan Tarng Yu Electronics Co., Ltd., Dongguan City (CN); Tarng Tu Enterprise co., ltd., New Taipei City (CN)

(72) Inventors: YING-CHUNG CHEN, New Taipei City (TW); MU-JUNG HUANG, New Taipei City (TW)

(21) Appl. No.: 19/074,489

(22) Filed: Mar. 10, 2025

(30) Foreign Application Priority Data
Mar. 11, 2024 (TW) 113108886

(51) Int. Cl. H01R 13/703

(52) U.S. Cl. CPC H01R 13/7036

(57) ABSTRACT

An electrical connector that can provide insertion or extraction of a pair of conductive components. The electrical connector includes: a pair of mating terminals and a resisting member. During the insertion of the butt conductive member into the electrical connector, the abutment member can abut against the butt conductive member to reduce the gap between the butt conductive member and the abutment block, so as to reduce the gap between the butt conductive member and the abutment block. The extent to which arcing occurs between the mating terminals. During the process of the butt conductive member pulling out the electrical connector, the butt conductive member sequentially leaves the butt terminal and the resisting member to reduce the degree of arcing between the butt conductive member and the butt terminal, and Ensure that the signal transmission function of the electrical connector meets expectations.

### CROSS-REFERENCE TO RELATED APPLICATIONS

This application claims the priority of Republic of China Patent Application No. 113108886 filed on Mar. 11, 2024, in the State Intellectual Property Office of the R.O.C., the disclosure of which is incorporated herein by reference.

### BACKGROUND OF THE INVENTION

### Field of the Invention

The present application relates to the technical field of electronic devices, and more particularly, to an electrical connector capable of reducing the occurrence of electric arcs at the moment of insertion or withdrawal of a joining conductive component.

### Descriptions of the Related Art

An electrical connector provides the joining of a joining conductive component for signal transmission. Accordingly, in recent years, electrical connectors have been widely applied to various electronic devices. In specific implementations, the joining conductive component may be inserted into or withdrawn from the electrical connector.

However, at the moment when the joining conductive component is inserted into or withdrawn from the electrical connector, electric arcs are likely to occur. This may lead to a risk of fire, potentially reduce the service life of the electrical connector, and even affect signal transmission between the electrical connector and the joining conductive component.

In view of the foregoing, how to reduce the occurrence of electric arcs between the electrical connector and the joining conductive component comprises become an urgent technical issue for those skilled in the art.

### SUMMARY OF THE INVENTION

In view of the drawbacks of the prior art mentioned above, the present application provides an electrical connector, which provides insertion or withdrawal of a joining conductive component, the electrical connector comprising: a joining terminal, the joining terminal comprising a terminal joining structure; an abutting component, the abutting component comprising an abutting block and an abutting arm, the abutting block and the abutting arm being combined into one unit, and the abutting block comprising an abutting block abutting structure; and an insulation core, the insulation core comprising a core joining passage and a core joining space, the core joining passage being in continuity with the core joining space, wherein the insulation core is respectively mated with the abutting arm and the joining terminal, allowing the abutting block to enter the core joining passage, and allowing the terminal joining structure to enter the core joining space; during the insertion process of the joining conductive component, the joining conductive component enters the core joining space through the core joining passage, allowing the terminal joining structure to join the joining conductive component within the core joining space, and the abutting arm can force the abutting block to move to allow the abutting block abutting structure to abut the joining conductive component, reducing the gap between the joining conductive component and the abutting block, wherein the abutting block abuts the joining conductive component earlier than the terminal joining structure joins the joining conductive component; and during the withdrawal process of the joining conductive component, the joining conductive component exits the core joining space through the core joining passage, allowing the joining conductive component to sequentially exit the terminal joining structure and the abutting block.

Preferably, the electrical connector said above, wherein the abutting block is an insulation block, and when the joining conductive component exits the terminal joining structure, the abutting block acts as an insulation barrier between the joining conductive component and the terminal joining structure, reducing the occurrence of arcing between the joining conductive component and the terminal joining structure.

Preferably, the electrical connector said above, wherein the joining terminal and the abutting arm are conductive metal bodies, the abutting block is a conductive plastic block, and the joining terminal, the abutting arm, and the abutting block are electrically connected, when the joining conductive component exits the terminal joining structure, the abutting block electrically abuts the joining conductive component to reduce the occurrence of arcing between the joining conductive component and the terminal joining structure.

Preferably, the electrical connector said above, wherein the abutting arm comprises an abutting arm mating extension section, an abutting arm abutting extension section, and an abutting arm elastic extension section, wherein the abutting block is mated with the abutting arm abutting extension section, and the insulation core is mated with the abutting arm mating extension section, allowing the abutting arm elastic extension section to provide thrust to the abutting arm abutting extension section, thereby allowing the abutting arm abutting extension section to force the abutting arm abutting extension section to move the abutting block.

Preferably, the electrical connector said above, wherein the insulation core further comprises a path limiting structure, and when the movement of the abutting block exceeds the path, the path limiting structure can abut the abutting arm abutting extension section, limiting the movement path of the abutting block, allowing the abutting block abutting structure to abut the joining conductive component at a predetermined position.

Preferably, the electrical connector said above, wherein the insulation core further comprises a core internal space, the core joining passage being in continuity with the core internal space, the abutting block comprising an abutting block actuating structure, during the insertion process of the joining conductive component, the joining conductive component can actuate the abutting block through the abutting block actuating structure, allowing part of the abutting block to enter the core internal space to avoid the abutting block from interfering with the entry of the joining conductive component into the core joining space.

Preferably, the electrical connector said above, wherein the abutting block actuating structure is a chamfer structure adjacent to the abutting block abutting structure.

Preferably, the electrical connector said above, wherein the joining terminal comprises a joining terminal mating extension section, a joining terminal joining extension section, and a joining terminal elastic extension section, wherein the terminal joining structure is disposed on the joining terminal joining extension section, and the insulation core is mated with the joining terminal mating extension section, allowing the joining terminal elastic extension section to provide thrust to the joining terminal joining extension section, thereby allowing the terminal joining structure to join the joining conductive component.

Preferably, the electrical connector said above, wherein the insulation core further comprises a core internal space, the joining terminal comprising a joining terminal actuating structure, during the insertion process of the joining conductive component, the joining conductive component can actuate the joining terminal through the joining terminal actuating structure, allowing part of the joining terminal to enter the core internal space to avoid the joining terminal from interfering with the entry of the joining conductive component into the core joining space.

Preferably, the electrical connector said above, wherein the joining terminal actuating structure is a chamfer structure adjacent to the terminal joining structure.

Preferably, the electrical connector said above, wherein the joining terminal actuating structure and the terminal joining structure can combine to form a bent structure.

Compared to prior art, the present application provides an electrical connector, which allows the insertion or withdrawal of a joining conductive component. The electrical connector comprises a joining terminal and an abutting component. During the insertion of the joining conductive component into the electrical connector, the abutting component abuts against the joining conductive component, thereby reducing the gap between the joining conductive component and the abutting block to mitigate the occurrence of arcing between the joining conductive component and the joining terminal. During the withdrawal of the joining conductive component from the electrical connector, the joining conductive component sequentially departs from the joining terminal and the abutting component, thereby mitigating the occurrence of arcing between the joining conductive component and the joining terminal, ensuring that the signal transmission function of the electrical connector meets expectations, and enabling the electrical connector to be widely applied to various electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic view of an electrical connector of the present application from a first viewing angle in an embodiment.

FIG. 2 is a three-dimensional schematic view of the electrical connector of the present application from a second viewing angle in an embodiment.

FIG. 3 is a rear schematic view of the electrical connector of the present application in an embodiment.

FIG. 4 is a sectional schematic view of a partial component of the electrical connector shown in FIG. 3, taken along line AA.

FIG. 5 is a sectional schematic view of a partial component of the electrical connector shown in FIG. 3, taken along line A′A′.

FIG. 6 is a sectional schematic view of a partial component of the electrical connector shown in FIG. 3, taken along line A″A″.

FIG. 7 is a three-dimensional schematic view of an electrical connector of the present application from a first viewing angle in an embodiment.

FIG. 8 is a three-dimensional schematic view of the electrical connector of the present application from a second viewing angle in an embodiment.

FIG. 9 is a front schematic view of the electrical connector of the present application in an embodiment.

FIG. 10 is a sectional schematic view of a partial component of the electrical connector shown in FIG. 9, taken along line BB.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

The present application provides an electrical connector, which allows the insertion or withdrawal of a joining conductive component. The electrical connector comprises a joining terminal and an abutting component. During the insertion of the joining conductive component into the electrical connector, the abutting component abuts against the joining conductive component, thereby reducing the gap between the joining conductive component and the abutting block to decrease the degree of arc occurrence between the joining conductive component and the joining terminal. During the withdrawal of the joining conductive component from the electrical connector, the joining conductive component sequentially disengages from the joining terminal and the abutting component to reduce the degree of arc occurrence between the joining conductive component and the joining terminal.

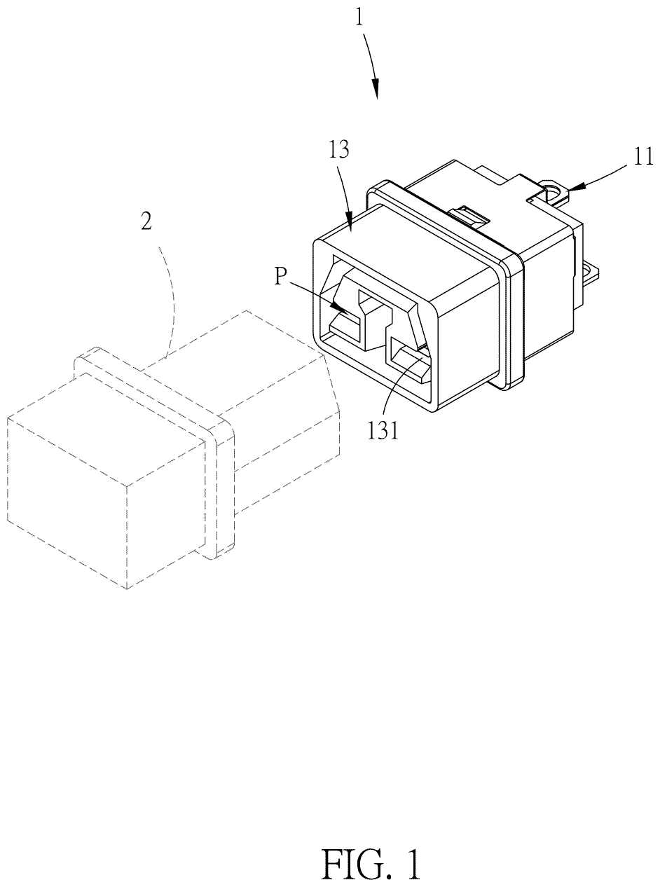

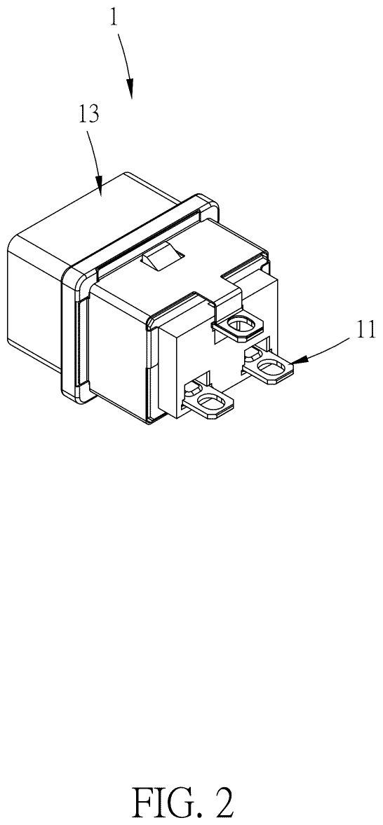

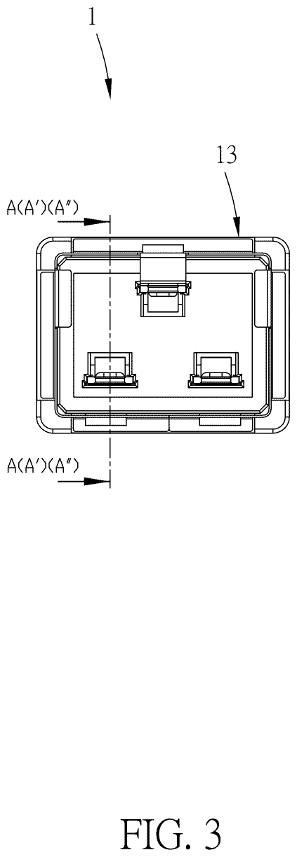

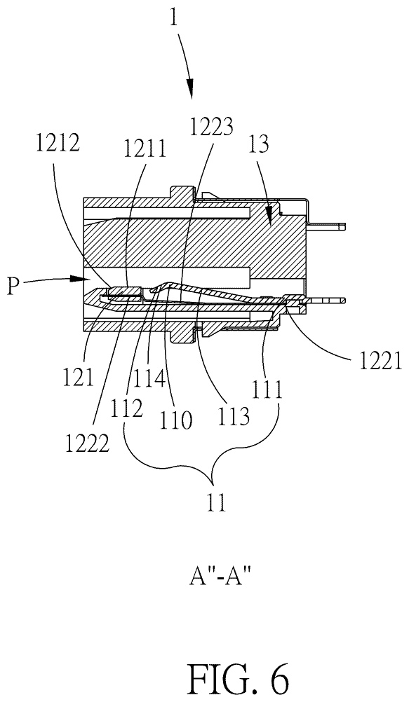

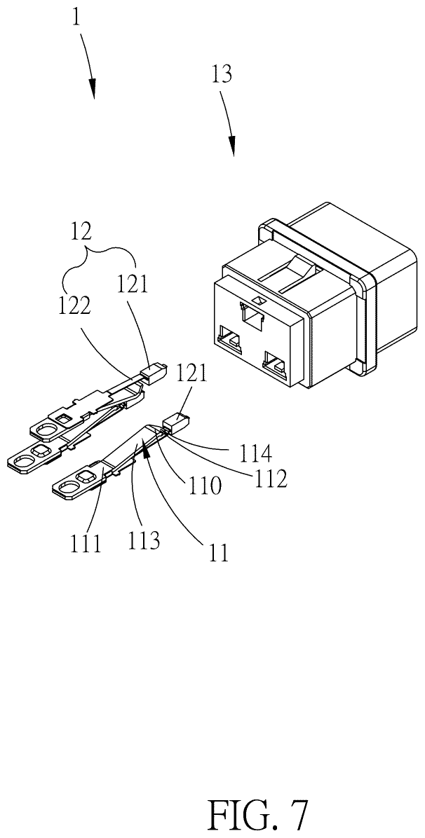

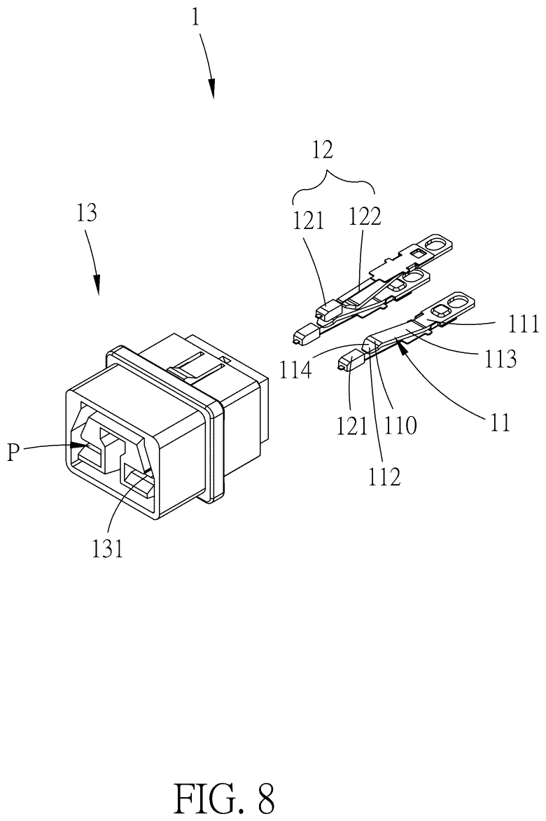

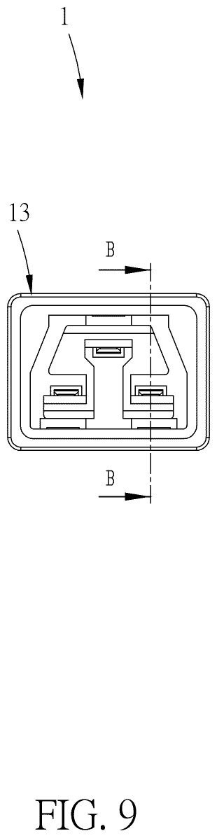

For a detailed description of the embodiments disclosed in the present application, please refer to FIGS. 1 to 10.

In the embodiments shown in FIGS. 1 to 10, at least one electrical connector 1 is provided, which allows the insertion or withdrawal of a joining conductive component 2. The electrical connector 1 comprises a joining terminal 11, an abutting component 12, and an insulation core 13.

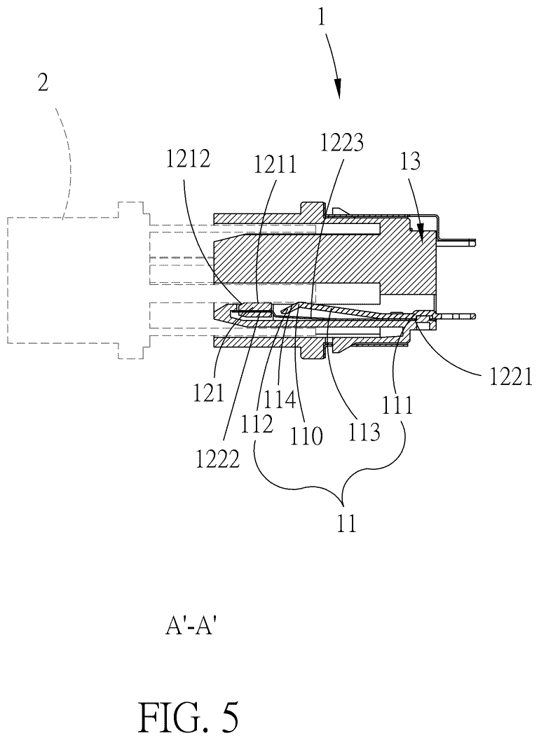

The joining terminal 11 transmits signals and comprises a terminal joining structure 110, a joining terminal mating extension section 111, a joining terminal joining extension section 112, a joining terminal elastic extension section 113, and a joining terminal actuating structure 114. As shown in FIGS. 5 to 8 and FIG. 10, the terminal joining structure 110 is disposed on the joining terminal joining extension section 112.

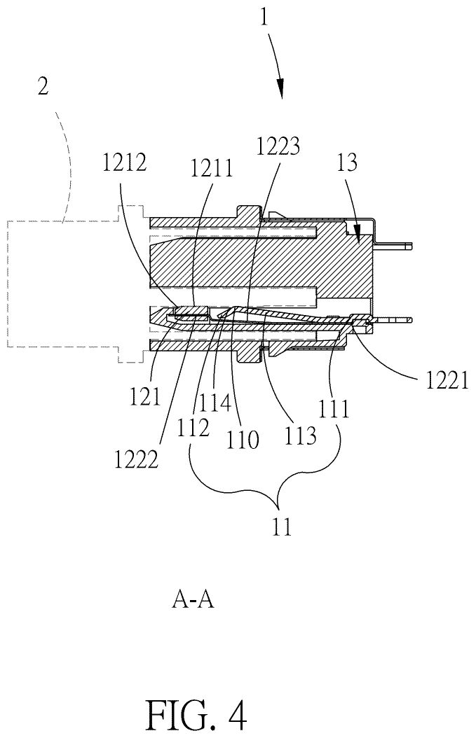

The abutting component 12 abuts against the joining conductive component 2 and comprises an abutting block 121 and an abutting arm 122. The abutting block 121 comprises an abutting block abutting structure 1211. Optionally, as shown in FIGS. 4 to 5, the abutting block abutting structure 1211 provides an abutting surface for surface abutment against the joining conductive component 2. The abutting arm 122 comprises an abutting arm mating extension section 1221, an abutting arm abutting extension section 1222, and an abutting arm elastic extension section 1223. In the above embodiments, the abutting block 121 is joined with the abutting arm abutting extension section 1222, integrating the abutting block 121 and the abutting arm 122 as a unit.

The insulation core 13 comprises a core joining passage P, a core joining space S1, and a core internal space S2. The core joining passage P is in continuity with the core joining space S1 and the core internal space S2. The insulation core 13 is mated with the abutting arm mating extension section 1221, enabling the abutting arm elastic extension section 1223 to provide thrust to the abutting arm abutting extension section 1222, thereby forcing the abutting block 121 to move so that the abutting block 121 enters the core joining passage P from the core internal space S2.

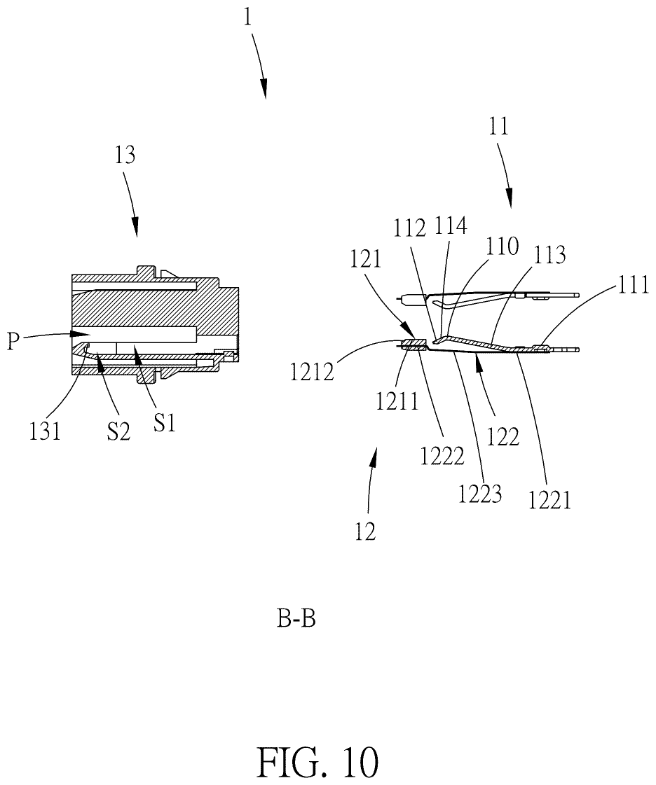

The insulation core 13 further comprises a path limiting structure 131. Optionally, as shown in FIG. 10, the path limiting structure 131 is a blocking wall structure that limits the movement of the abutting arm abutting extension section 1222. When the movement of the abutting block 121 exceeds its path range, the path limiting structure 131 abuts against the abutting arm abutting extension section 1222 to limit the movement path of the abutting block 121, ensuring that the abutting block abutting structure 1211 abuts against the joining conductive component 2 at a predetermined position within the core joining passage P.

In the above embodiments, the insulation core 13 is mated with the joining terminal mating extension section 111, enabling the joining terminal elastic extension section 113 to provide thrust to the joining terminal joining extension section 112, thereby allowing the terminal joining structure 110 to enter the core joining space S1 and join the joining conductive component 2.

It should be noted that during the insertion process of the joining conductive component 2, the joining conductive component 2 can enter the core joining space S1 via the core joining passage P, such that the terminal joining structure 110 can join the joining conductive component 2 within the core joining space S1. During the insertion process of the joining conductive component 2, the abutting arm 122 can force the abutting block 121 to actuate, allowing the abutting block abutting structure 1211 to abut against the joining conductive component 2, thereby reducing the gap between the joining conductive component 2 and the abutting block 121. Additionally, during the insertion process of the joining conductive component 2, the abutting block 121 abuts against the joining conductive component 2 earlier than the terminal joining structure 110 joins the joining conductive component 2. In this way, the degree of arcing between the joining conductive component 2 and the terminal joining structure 110 can be reduced, thereby addressing the issue of arcing that easily occurs at the moment the joining conductive component 2 is inserted into the electrical connector 1.

It should be noted that during the extraction process of the joining conductive component 2, the joining conductive component 2 exits the core joining space S1 via the core joining passage P, such that the joining conductive component 2 sequentially exits the terminal joining structure 110 and the abutting block 121. In this way, the degree of arcing between the joining conductive component 2 and the terminal joining structure 110 can be reduced, thereby addressing the issue of arcing that easily occurs at the moment the joining conductive component 2 is extracted from the electrical connector 1.

For example, the abutting block 121 can be selected as an insulating block. At the moment the joining conductive component 2 exits the terminal joining structure 110, the abutting block 121 can serve as an insulating barrier between the joining conductive component 2 and the terminal joining structure 110, thereby reducing the degree of arcing between the joining conductive component 2 and the terminal joining structure 110, preventing ignition, and enhancing the lifespan of the electrical connector 1. This ensures that the signal transmission function between the electrical connector 1 and the joining conductive component 2 meets expectations and can be widely applied to various electronic devices.

For example, the joining terminal 11 and the abutting arm 122 can be selected as conductive metal bodies, and the abutting block 121 can be selected as a conductive plastic block. Correspondingly, the joining terminal 11, the abutting arm 122, and the abutting block 121 are electrically connected. Therefore, at the moment the joining conductive component 2 exits the terminal joining structure 110, the abutting block 121 can electrically abut against the joining conductive component 2, thereby reducing the degree of arcing between the joining conductive component 2 and the terminal joining structure 110, preventing ignition, and enhancing the lifespan of the electrical connector 1. This ensures that the signal transmission function between the electrical connector 1 and the joining conductive component 2 meets expectations and can be widely applied to various electronic devices.

In the embodiments shown in FIGS. 4 to 6 and FIG. 10, the abutting block 121 comprises an abutting block actuating structure 1212. Optionally, as shown in FIGS. 4 to 5, the abutting block actuating structure 1212 is a pushing surface that allows the joining conductive component 2 to push against it. During the insertion process of the joining conductive component 2, the joining conductive component 2 can actuate the abutting block 121 by pushing against the abutting block actuating structure 1212, allowing part of the abutting block 121 to enter the core internal space S2 from the core joining space S1, thereby preventing the abutting block 121 from interfering with the joining conductive component 2 entering the core joining space S1. In the above embodiments, the abutting block actuating structure 1212 is a chamfered structure adjacent to the abutting block abutting structure 1211, allowing the joining conductive component 2 to push against the abutting block actuating structure 1212 as expected and enabling the abutting block abutting structure 1211 to abut against the joining conductive component 2 as expected.

In the embodiments shown in FIGS. 4 to 8 and FIG. 10, the joining terminal 11 comprises a joining terminal actuating structure 114. Optionally, as shown in FIGS. 4 to 5, the joining terminal actuating structure 114 is a pushing structure that allows the joining conductive component 2 to push against it. During the insertion process of the joining conductive component 2, the joining conductive component 2 can actuate the joining terminal 11 by pushing against the joining terminal actuating structure 114, allowing part of the joining terminal 11 to enter the core internal space S2 from the core joining space S1, thereby preventing the joining terminal 11 from interfering with the joining conductive component 2 entering the core joining space S1. In the above embodiments, the joining terminal actuating structure 114 is a chamfered structure adjacent to the terminal joining structure 110, allowing the joining conductive component 2 to push against the joining terminal actuating structure 114 as expected and enabling the terminal joining structure 110 to join the joining conductive component 2 as expected. Additionally, the joining terminal actuating structure 114 and the terminal joining structure 110 can be combined to a bending structure, ensuring that the structural strength of the joining terminal actuating structure 114 and the terminal joining structure 110 meets expectations.

It should be noted that the electrical connector of this application may omit certain components and is not limited to the above embodiments.

For example, the electrical connector of this application may be selected to comprise only a joining terminal, an abutting component, and an insulation core. The joining terminal comprises a terminal joining structure. The abutting component comprises an abutting block and an abutting arm, which are integrated as a unit, and the abutting block comprises an abutting block abutting structure. The insulation core comprises a core joining passage and a core joining space, where the core joining passage is in continuity with the core joining space. The insulation core mates with the abutting arm and the joining terminal separately, allowing the abutting block to enter the core joining passage, and allowing the terminal joining structure to enter the core joining space. During the insertion process of the joining conductive component, the joining conductive component enters the core joining space via the core joining passage, enabling the terminal joining structure to join the joining conductive component within the core joining space. The abutting arm can force the abutting block to actuate, allowing the abutting block abutting structure to abut against the joining conductive component, thereby reducing the gap between the joining conductive component and the abutting block. The abutting block abuts against the joining conductive component earlier than the terminal joining structure joins the joining conductive component. During the extraction process of the joining conductive component, the joining conductive component exits the core joining space via the core joining passage, sequentially leaving the terminal joining structure and the abutting block.

In summary, this application provides an electrical connector that allows for the insertion or extraction of a joining conductive component. The electrical connector comprises a joining terminal and an abutting component. During the insertion process of the joining conductive component into the electrical connector, the abutting component can abut against the joining conductive component, reducing the gap between the joining conductive component and the abutting block to minimize the degree of arcing between the joining conductive component and the joining terminal. During the extraction process of the joining conductive component from the electrical connector, the joining conductive component sequentially leaves the joining terminal and the abutting component, reducing the degree of arcing between the joining conductive component and the joining terminal, ensuring that the signal transmission function of the electrical connector meets expectations, and allowing the electrical connector to be widely applied to various electronic devices.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector, which provides insertion or withdrawal of a joining conductive component, the electrical connector comprising:
a joining terminal, the joining terminal comprising a terminal joining structure;
an abutting component, the abutting component comprising an abutting block and an abutting arm, the abutting block and the abutting arm being combined into one unit, and the abutting block comprising an abutting block abutting structure; and
an insulation core, the insulation core comprising a core joining passage and a core joining space, the core joining passage being in continuity with the core joining space, wherein
the insulation core is respectively mated with the abutting arm and the joining terminal, allowing the abutting block to enter the core joining passage, and allowing the terminal joining structure to enter the core joining space;
during the insertion process of the joining conductive component, the joining conductive component enters the core joining space through the core joining passage, allowing the terminal joining structure to join the joining conductive component within the core joining space, and the abutting arm can force the abutting block to move to allow the abutting block abutting structure to abut the joining conductive component, reducing the gap between the joining conductive component and the abutting block, wherein the abutting block abuts the joining conductive component earlier than the terminal joining structure joins the joining conductive component; and
during the withdrawal process of the joining conductive component, the joining conductive component exits the core joining space through the core joining passage, allowing the joining conductive component to sequentially exit the terminal joining structure and the abutting block.

2. The electrical connector of claim 1, wherein the abutting block is an insulation block, and when the joining conductive component exits the terminal joining structure, the abutting block acts as an insulation barrier between the joining conductive component and the terminal joining structure, reducing the occurrence of arcing between the joining conductive component and the terminal joining structure.

3. The electrical connector of claim 1, wherein the joining terminal and the abutting arm are conductive metal bodies, the abutting block is a conductive plastic block, and the joining terminal, the abutting arm, and the abutting block are electrically connected, when the joining conductive component exits the terminal joining structure, the abutting block electrically abuts the joining conductive component to reduce the occurrence of arcing between the joining conductive component and the terminal joining structure.

4. The electrical connector of claim 1, wherein the abutting arm comprises an abutting arm mating extension section, an abutting arm abutting extension section, and an abutting arm elastic extension section, wherein the abutting block is mated with the abutting arm abutting extension section, and the insulation core is mated with the abutting arm mating extension section, allowing the abutting arm elastic extension section to provide thrust to the abutting arm abutting extension section, thereby allowing the abutting arm abutting extension section to force the abutting arm abutting extension section to move the abutting block.

5. The electrical connector of claim 4, wherein the insulation core further comprises a path limiting structure, and when the movement of the abutting block exceeds the path, the path limiting structure can abut the abutting arm abutting extension section, limiting the movement path of the abutting block, allowing the abutting block abutting structure to abut the joining conductive component at a predetermined position.

6. The electrical connector of claim 1, wherein the insulation core further comprises a core internal space, the core joining passage being in continuity with the core internal space, the abutting block comprising an abutting block actuating structure, during the insertion process of the joining conductive component, the joining conductive component can actuate the abutting block through the abutting block actuating structure, allowing part of the abutting block to enter the core internal space to avoid the abutting block from interfering with the entry of the joining conductive component into the core joining space.

7. The electrical connector of claim 6, wherein the abutting block actuating structure is a chamfer structure adjacent to the abutting block abutting structure.

8. The electrical connector of claim 1, wherein the joining terminal comprises a joining terminal mating extension section, a joining terminal joining extension section, and a joining terminal elastic extension section, wherein the terminal joining structure is disposed on the joining terminal joining extension section, and the insulation core is mated with the joining terminal mating extension section, allowing the joining terminal elastic extension section to provide thrust to the joining terminal joining extension section, thereby allowing the terminal joining structure to join the joining conductive component.

9. The electrical connector of claim 1, wherein the insulation core further comprises a core internal space, the joining terminal comprising a joining terminal actuating structure, during the insertion process of the joining conductive component, the joining conductive component can actuate the joining terminal through the joining terminal actuating structure, allowing part of the joining terminal to enter the core internal space to avoid the joining terminal from interfering with the entry of the joining conductive component into the core joining space.

10. The electrical connector of claim 9, wherein the joining terminal actuating structure is a chamfer structure adjacent to the terminal joining structure.

11. The electrical connector of claim 9, wherein the joining terminal actuating structure and the terminal joining structure can combine to form a bent structure.
